(19) United States
(12) Patent Application Publication
(10) Pub. No.: US 2008/0105332 A1
(43) Pub. Date: May 8, 2008

(54) Aerial Saw with Landing Legs

(76) Inventor: John William Lippits, Balgowlah (AU)

Correspondence Address: MICHAEL MOLINS;MOLINS & CO., SUITE 5, LEVEL 6, 139 MACQUARIE ST, SYDNEY NSW, 2000, omitted

(21) Appl. No.: 11/934,072

(22) Filed: Nov. 1, 2007

(30) Foreign Application Priority Data
Nov. 2, 2006 (AU) 2006906102

(51) Int. Cl. A01G 23/00

(52) U.S. Cl. 144/24.13

(57) ABSTRACT

An aerial saw is deployable from a flying craft such as a helicopter. The aerial saw comprises a main beam along with a plurality of circular saw blades are vertically arranged. Rollable landing legs are attached to the lower end of the main beam, for the purpose of releasing the aerial saw from the helicopter. The landing legs comprise first and second landing legs. A lower cross bar between the landing legs helps define a floor area upon the engine for the saws is carried. Metal plates that preferably comprise ventilation or protective elements may be further provided to create a protective cage between the landing legs and the main beam.

### FIELD OF THE INVENTION

This invention relates to aerial saws, more particularly, to aerial saws with landing legs.

### BACKGROUND OF THE INVENTION

Disclosed in the international PCT publication WO2004/103063 is an aerial saw, which is suspended from a helicopter and used to trim trees. For aerial saws of this type, a specialised trailer or landing base is present on the ground at the time the aerial saw is ready for storage. In the event that the landing base is not available or is delayed, the helicopter is forced to loiter while carrying the heavy aerial saw until the arrival of the landing base.

### OBJECT AND SUMMARY OF THE INVENTION

Accordingly, it is an object of the present invention to provide an aerial saw with landing legs. The saw can be released from the helicopter without a ground trailer.

It is another object of the present invention to provide a protective ventilated cage for the engine that drives the aerial saw.

It is a further object of the present invention to provide wheels on the saw for ease of loading onto a vehicle.

In preferred embodiments, the landing legs further define an internal space for the engine. In some preferred embodiments, aluminium plates shelter this space and form a protective cage for the engine or other related components.

### BRIEF DESCRIPTION OF THE DRAWING FIGURES

In order that the invention be better understood, reference is now made to the following drawing figures in which:

FIG. 1 is an elevation view of the prior art;

FIG. 2 is a side elevation view of the aerial saw with landing legs;

FIG. 3 is a front perspective view of the landing legs;

FIG. 4 is a view of another embodiment of the landing legs with wheels;

FIG. 5 is side elevation view of a still another embodiment of the landing legs;

FIG. 6 is a front perspective view of the embodiment of the landing leg shown in FIG. 5.

### BEST MODE AND OTHER EMBODIMENTS

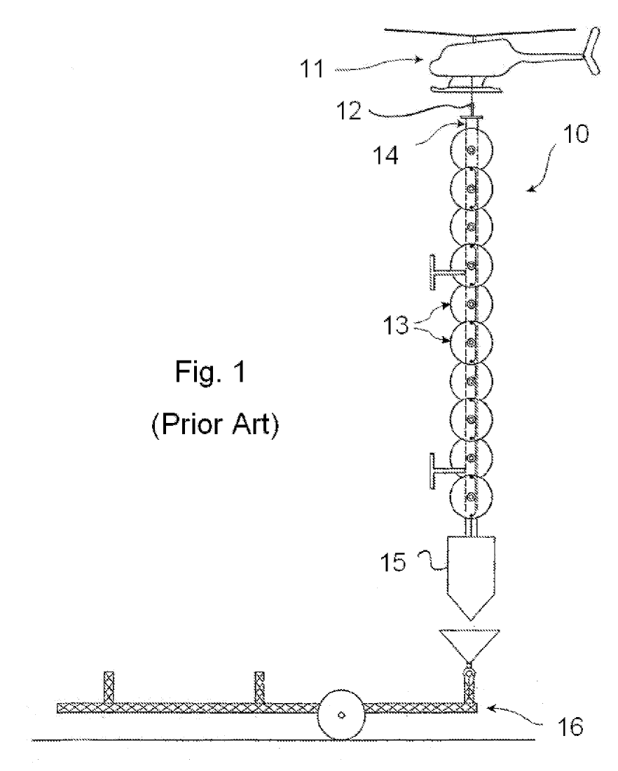

FIG. 1 depicts an aerial saw 10 of the prior art, suspended from a helicopter 11 by a suspension system 12. A plurality of circular saw blades 13 are vertically arranged along a main beam 14. Located on the lower end of the main beam 14 is a housing 15 for the engine that drives the saw blades 13. As shown in FIG. 1, this aerial saw of the prior art 10 can only be safely released from the helicopter 11 when a cooperating landing base 16 is present on the ground.

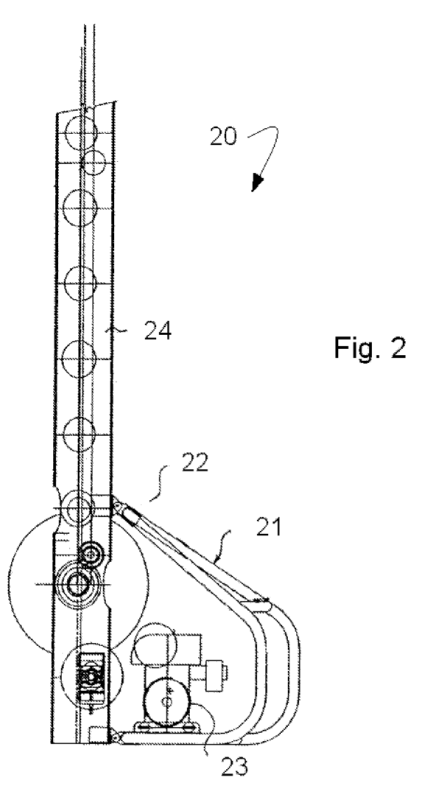

FIG. 2 shows an aerial saw 20 of the present technology, which does not have the housing 15, but instead comprises tubular landing legs 21 forming a landing gear on the lower end 22 of the main beam 24. The landing gear and its landing legs 21 also serve as a frame for carrying the engine 23 that drives the circular saw blades 13. The legs are preferably fabricated from aircraft quality aluminium or steel tubes.

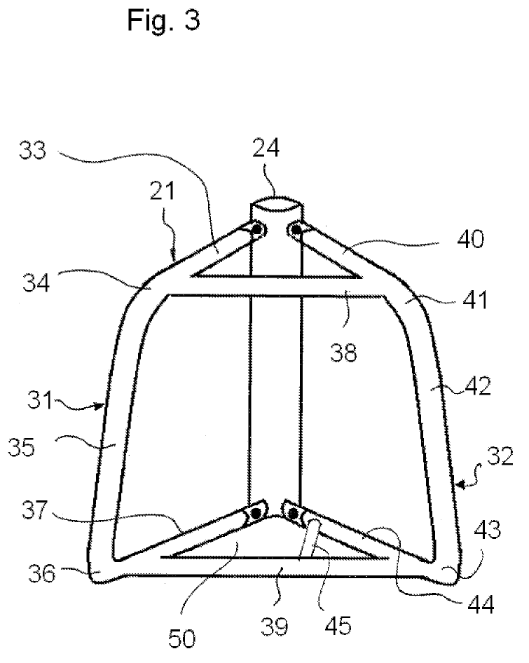

As shown in FIG. 3, the landing gear and its the landing legs 21 comprise a first leg 31 and a second leg 32, both of which are approximately U shaped. The legs 31, 32 have free ends that extend from the main beam 24, and comprise first (or upper) leg portions 33, 40 which extend between the main beam 14 and the upper bends 34, 41. Second leg portions 35, 42 extend between the upper bends and the lower bend 36, 43. The second leg portions are approximately parallel with the main beam 24. Third leg portions 37, 44 extend between the lower bends 36, 43 and the main beam 24. The upper bends 34, 41 and the lower bends 36, 44 are radiused for strength and rolling action.

The landing legs 21 further comprise an upper cross bar 38 connecting the first portions 33, 40. The upper cross bar 38 in this example is located above the upper rounded bends 34, 41. There is also a lower cross bar 39 between the third leg portions 37, 44. The lower cross bar and the third leg portions enclose a floor area 50, above which the engine is carried. The legs 31, 32 are of such dimension that space enclosed by the landing legs is large enough for the engine 23. Floor bars 45 may be welded across the floor area 50 (as shown in FIG. 3), as required, for better supporting the engine or accessories such as wheels.

The rounded bends permit the landing legs 21 and thus the entire saw to roll as the aerial saw is being steadily lowered or raised. When the aerial saw is fully released and detached from the helicopter, the landing legs rest primarily on the second portions 35, 42, while the aerial saw is laid on the ground.

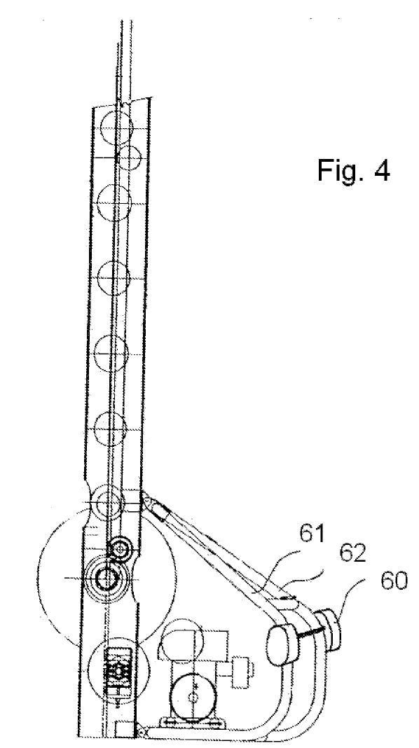

As shown in FIG. 4, an alternate embodiment of the landing legs of the present invention comprises fixed or retractable wheels 60 that allow the aerial saw to be manoeuvred on the ground. The wheels may be located inboard or outboard of the legs 61, 62. The wheels 60 must be sturdy enough to support the weight of the aerial saw when it is on the ground. The wheels 60 allow it to be manoeuvred on to and off of a vehicle equipped with the appropriate ramp. In preferred embodiments, the wheels 60, their retraction mechanism and any braking components associated with the wheels 60 are aircraft specification components.

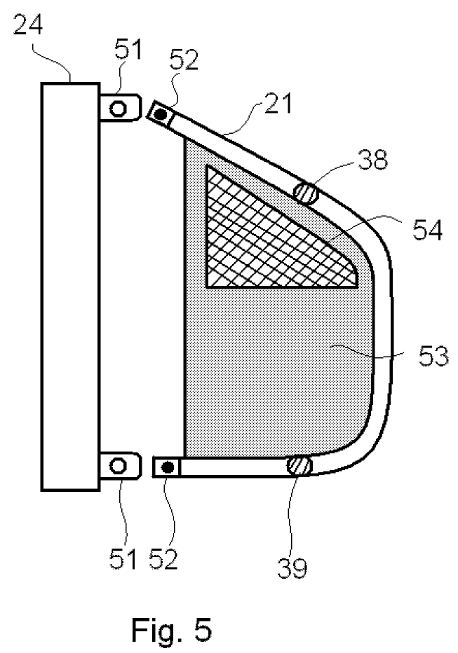

As shown in FIG. 5, the landing legs 21 and the main beam 24 may each further comprise cooperating fastening components 51, 52 at each free end of each leg, so that the landing legs 21 can be are easily detached from the main beam 24. This example also includes metal plates 53 that enclose and protect the space defined by the legs. These plates substantially enclose the space between the landing legs and the main beam, forming a protective cage. In further preferred embodiments, the plates 53 include meshed or barred windows 54, which allow ventilation for the engine.

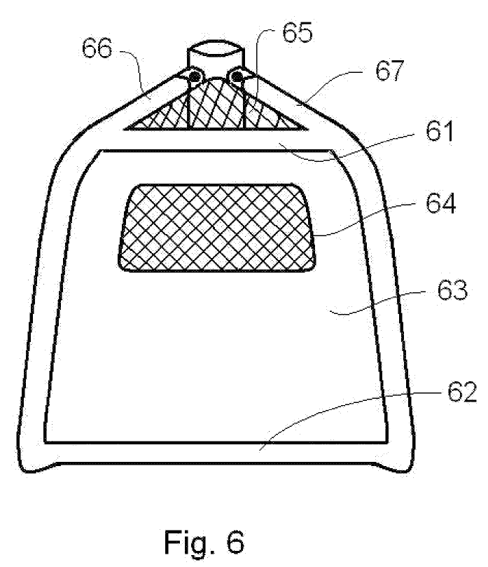

Referring to FIG. 6, the area between the upper and lower cross bars 61, 62 may also be substantially closed off by a plate 63. In further embodiments the plate 63 also comprises a ventilation window 64. There may further be a protective or ventilating element such as a mesh 65 between the upper cross bar 61 and the first leg portions 66, 67.

While the present invention has been disclosed with reference to particular details of construction, these should be understood as having been provided by way of example and not as limitations to the scope or spirit of the invention.

What is claimed is:

1. An aerial saw, comprising:
a main beam having a lower end;
a plurality of saw blades arranged along the main beam;
an engine for driving the saw blades, and
a landing gear located on the lower end of the main beam.

2. The aerial saw of claim 1, wherein,
the landing gear further comprising tubular portions, attached to the beam, the tubular portions having radiused bends;
the bends being radiused for a rolling action of the landing gear.

3. The aerial saw of claim 1, wherein,
the landing gear further carries a landing wheel.

4. The aerial saw of claim 3, wherein,
the landing wheel is carried outboard of the landing gear.

5. The aerial saw of claim 1, wherein,
the landing gear is detachable from the main beam.

6. The aerial saw of claim 1, wherein,
the landing gear comprises a first and a second landing leg tubes.

7. The aerial saw of claim 6, further comprising,
one or more cross bars extending between the landing leg tubes.

8. The aerial saw of claim 2, wherein,
the engine is carried on a floor area located between the tubular portions.

9. The aerial saw of claim 8, further comprising,
one or more plates that substantially spans at least some of the tubular portions to form a protective cage.

10. The aerial saw of claim 8, wherein,
the protective cage further comprises an element that is a mesh.

11. The aerial saw of claim 9, wherein,
at least one plate comprises a ventilation window.

12. The aerial saw of claim 6, wherein,
each landing leg tube further comprising a first leg portion between the main beam and an upper bend, a second leg portion between the upper bend and a lower bend, and a third leg portion between the lower bend and the main beam.

13. The aerial saw of claim 12, wherein,
at least the lower bend is radiused for a rolling action of the landing leg.

14. The aerial saw of claim 4, wherein,
the landing leg is detachable from the main beam.

15. The aerial saw of claim 3, wherein,
the landing wheel is retractable.

16. An aerial saw, comprising:
a main beam having a lower end;
a plurality of saw blades arranged along the main beam;
an engine for driving the saw blades, and
a landing gear located on the lower end of the main beam;
the landing gear further comprising tubular portions, attached to the beam, the tubular portions having radiused bends;
the bends being radiused for a rolling action of the landing gear;
the landing gear further carrying a landing wheel;
the tubular portions comprising a first and a second landing leg tubes;
the engine is carried on a floor area located between the tubes.

17. The aerial saw of claim 16, further comprising,
one or more plates that spans at least a portion of the leg tubes to form a protective cage.

18. The aerial saw of claim 17, wherein,
the landing wheel is retractable.

19. The aerial saw of claim 17, wherein,
each landing leg tube further comprising a lower bend, and a third leg portion between the lower bend and the main beam.

20. The aerial saw of claim 19, wherein,
at least the lower bend is radiused for a rolling action of the landing leg.
